(19) United States
(12) Patent Application Publication
(10) Pub. No.: US 2023/0161802 A1
(43) Pub. Date: May 25, 2023

(54) METHOD AND DEVICE FOR CONSTRUCTING STANDARD KNOWLEDGE GRAPH, AND METHOD AND DEVICE FOR QUERYING STANDARD

(71) Applicants: China Electronics Standardization Institute, Beijing (CN); Beijing CESI Technology Co., Ltd, Beijing (CN); Shenzhen CESI Information Technology Co., Ltd., Shenzhen (CN)

(72) Inventors: Duofu CHENG, Beijing (CN); Xiangang LIU, Beijing (CN); Wenjian HAO, Beijing (CN); Mingying ZHANG, Beijing (CN); Hao ZHANG, Beijing (CN); Yanxuan GAO, Beijing (CN); Chen HU, Beijing (CN); Lixi WANG, Beijing (CN); Gang ZHOU, Shenzhen (CN); Mei WEI, Beijing (CN); Guan HUANG, Beijing (CN); Xiaohui LIU, Beijing (CN); Yuan XIE, Beijing (CN); Xueying HOU, Beijing (CN)

(73) Assignees: China Electronics Standardization Institute, Beijing (CN); Beijing CESI Technology Co., Ltd, Beijing (CN); Shenzhen CESI Information Technology Co., Ltd., Shenzhen (CN)

(21) Appl. No.: 18/155,590

(22) Filed: Jan. 17, 2023

Related U.S. Application Data
(63) Continuation of application No. PCT/CN2022/100958, filed on Jun. 24, 2022.

(30) Foreign Application Priority Data
Jun. 30, 2021 (CN) 202110733216.9

(51) Int. Cl. G06F 16/36; G06F 40/279; G06F 40/174

(52) U.S. Cl. CPC G06F 16/367; G06F 40/279; G06F 40/174; G06F 40/30

(57) ABSTRACT

The present application provides a method and a device for constructing standard knowledge graph, and a method and a device for querying standard. The method for constructing standard knowledge graph includes: querying and determining writing elements of a text of a standard in standard writing rules based on a category of the text of the standard, and determining a head entity type, a tail entity type and an entity relationship between a head entity and a tail entity in a standard knowledge graph based on the writing elements; extracting a head entity corresponding to the head entity type and a tail entity corresponding to the tail entity type from the text of the standard based on the head entity type, the tail entity type and the entity relationship; and performing entity filling on the standard knowledge graph based on the head entity and the tail entity.

### CROSS-REFERENCE TO RELATED APPLICATIONS

This application is a continuation of International Patent Application Number PCT/CN2022/100958 filed Jun. 24, 2022, which claims the benefit of priority to CN 202110733216.9 filed on Jun. 30, 2021, the contents of which are incorporated herein by reference in their entireties.

### FIELD OF TECHNOLOGY

The present application relates to the field of computer technology, and in particularly, to a method and a device for constructing standard knowledge graph, and a method and a device for querying standard.

### BACKGROUND

With the development of information technology and the advent of the digital economy era, the demand for digital transformation in traditional industries is imminent. Especially with the rapid development of the current standard digitalization process, it has been basically realized that text of a standard can be displayed in a machine-displayable standard form with digital format (such as PDF and WORD) as carrier. However, the text of the standard with this form can only meet the basic functions of browsing and querying. For example, when querying in a standard, it is common to enter keyword in an electronic document (such as a PDF document) of the standard to locate the position of the keyword in the document, and then manually read the context of the document to extract relevant data information. This method requires manual repeated reading to extract relevant data information every time a query in the standard is required, which is inefficient.

### SUMMARY

The present application provides a method and a device for constructing standard knowledge graph, and a method and a device for querying standard, which are used to overcome the defect of low efficiency of querying data information in a standard in related art.

The present application provides a method for constructing standard knowledge graph, including:
determining a category of a text of a standard;
querying and determining writing elements of the text of the standard in standard writing rules based on the category of the text of the standard, and determining a head entity type, a tail entity type and an entity relationship between a head entity and a tail entity in a standard knowledge graph based on the writing elements;
extracting a head entity corresponding to the head entity type and a tail entity corresponding to the tail entity type from the text of the standard based on the head entity type, the tail entity type and the entity relationship; and
performing entity filling on the standard knowledge graph based on the head entity and the tail entity.

According to the method for constructing standard knowledge graph provided by the present application, the writing elements include structured elements and unstructured elements.

According to the method for constructing standard knowledge graph provided by the present application, where the determining the head entity type, the tail entity type and the entity relationship between the head entity and the tail entity in the standard knowledge graph based on the writing elements includes:
in case the writing elements are structured elements, taking a preset relationship keyword as the entity relationship, and determining the head entity type and the tail entity type based on the entity relationship; and
in case the writing elements are unstructured elements, inputting a text of the standard corresponding to the unstructured elements into a reading comprehension model and obtaining an entity relationship outputted by the reading comprehension model, and determining the head entity type and the tail entity type based on the entity relationship; where the reading comprehension model is obtained by training with a sample text of standard and an entity relationship of the sample text of standard.

According to the method for constructing standard knowledge graph provided by the present application, where the extracting the head entity corresponding to the head entity type and the tail entity corresponding to the tail entity type from the text of the standard based on the head entity type, the tail entity type and the entity relationship includes:
determining an entity extraction rule based on the head entity type, the tail entity type and the entity relationship, and extracting the head entity corresponding to the head entity type and the tail entity corresponding to the tail entity type from the text of the standard based on the entity extraction rule.

According to the method for constructing standard knowledge graph provided by the present application, where the determining the category of the text of the standard includes:
determining whether a preset title keyword is in a title of the text of the standard; and
in case the preset title keyword is in the title of the text of the standard, determining the category of the text of the standard based on a mapping relationship between the preset title keyword and the category of the text of the standard; and
in case the preset title keyword is not in the title of the text of the standard, determining the category of the text of the standard based on a text content in a specified item in the text of the standard.

The present application also provides a device for constructing standard knowledge graph, including:
a category determining unit, configured to determine a category of a text of a standard;
a type determining unit, configured to query and determine writing elements of the text of the standard in standard writing rules based on the category of the text of the standard, and determine a head entity type, a tail entity type and an entity relationship between a head entity and a tail entity in a standard knowledge graph based on the writing elements;
an entity extracting unit, configured to extract a head entity corresponding to the head entity type and a tail entity corresponding to the tail entity type from the text of the standard based on the head entity type, the tail entity type and the entity relationship; and
an entity filling unit, configured to perform entity filling on the standard knowledge graph based on the head entity and the tail entity.

The present application also provides a method for querying standard, including:
determining a keyword of a standard to be queried, where the keyword comprises one or more of a head entity, a tail entity and an entity relationship between the head entity and the tail entity; and
determining query data corresponding to the keyword in a standard knowledge graph by taking the keyword as a node or an edge;
where the standard knowledge graph is obtained according to the method for constructing standard knowledge graph described above.

The present application also provides a device for querying standard, including:
a determining unit, configured to determine a keyword of a standard to be queried, where the keyword comprises one or more of a head entity, a tail entity and an entity relationship between the head entity and the tail entity; and
a querying unit, configured to determine query data corresponding to the keyword in a standard knowledge graph by taking the keyword as a node or an edge;
where the standard knowledge graph is obtained according to the method for constructing standard knowledge graph described above.

The present application also provides an electronic apparatus, including a processor and a memory storing computer program that is executable by the processor, where the computer program, when executed by the processor, causes the processor to perform the steps of any method for constructing standard knowledge graph described above; and/or the steps of any method for querying standard described above.

The present application also provides a non-transitory computer-readable storage medium having a computer program stored thereon, where the computer program, when executed by a processor, causes the processor to perform the steps of any method for constructing standard knowledge graph described above; and/or the steps of any method for querying standard described above.

In the method and device for constructing standard knowledge graph and method and device for querying standard, by determining the category of the text of the standard based on the title of the text of the standard; determining writing elements of the text of the standard based on the category of the text of the standard; and determining the head entity type, the tail entity type and the entity relationship between the head entity and the tail entity in the standard knowledge graph based on the writing elements, the standard knowledge graph can be constructed according to texts of the standards with different categories, which enables the constructed standard knowledge graph to accurately characterize the content information of texts of the standards with different categories, and then the corresponding standard data information can be queried and obtained quickly and accurately from the constructed standard knowledge graph, which can avoid the problem of low efficiency caused by manual reading and extracting standard data information in traditional methods.

### BRIEF DESCRIPTION OF THE SEVERAL VIEWS OF THE DRAWINGS

In order to more clearly illustrate solutions disclosed in the present application or the related art, the drawings used in the descriptions of the embodiments or the related art are briefly described below. It should be noted that the drawings in the following description are only certain embodiments of the present application, and other drawings can be obtained according to the drawings without any creative work for those skilled in the art.

FIG. 1 is a schematic flowchart of a method for constructing standard knowledge graph provided by the present application.

FIG. 2 is a schematic structural diagram of a standard knowledge graph provided by the present application.

FIG. 3 is a schematic structural diagram of a device for constructing standard knowledge graph provided by the present application.

FIG. 4 is a schematic flowchart of a method for querying standard provided by the present application.

FIG. 5 is a schematic structural diagram of a device for querying standard provided by the present application.

FIG. 6 is an electronic apparatus provided by the present application.

### DETAILED DESCRIPTION

In order to make the objectives, solutions and advantages of the present application more clear, the solutions of the present application are clearly and completely described below with reference to the accompanying drawings of the present application. It should be noted that the described embodiments are some embodiments of the present application, rather than all. All other embodiments obtained by those of ordinary skill in the art based on the embodiments of the present application without creative work fall within the scope of the present application.

When querying in a standard, it is common to enter keyword in a document (such as a PDF document) of the standard to locate the position of the keyword in the document, and then manually read the context of the document to extract relevant data information. This method requires manual repeated reading to extract relevant data information every time a query in the standard is required or propaganda and implementation of the standard are required, which is inefficient. For example, when querying the belonging department of standard A, it is required to enter a keyword “belonging department” to locate to the column “foreword” in the document, and further manually read context information to extract data information of the belonging department. This method may also miss or incorrectly query relevant data information due to human errors.

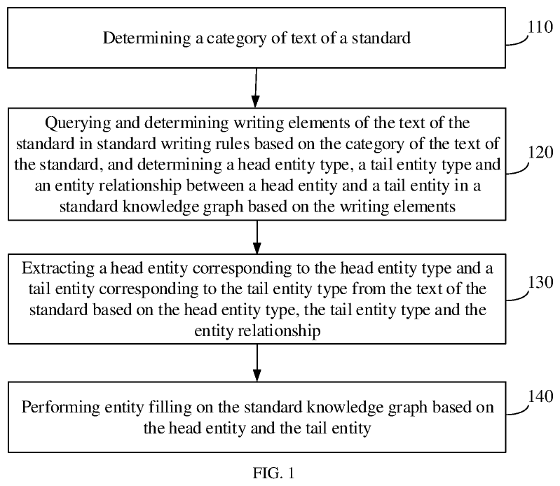

In view of this, the present application provides a method for constructing standard knowledge graph. FIG. 1 is a schematic flowchart of a method for constructing standard knowledge graph provided by the present application. As shown in FIG. 1, the method includes the steps as followings.

Step 110, determining a category of text of a standard.

In an embodiment, the text of a standard refers to a text written according to a standard writing rule (such as GB/T20001). The categories of the text of a standard can include symbol standard, classification label, testing method standard, norm standard, procedure standard, guideline standard, product standard, etc. The category of the text of a standard is obtained by classifying the text of the standard according to the content of the standard. Since the title of the text of a standard is used to briefly describe the content of the text of the standard, the category of the text of the standard can be determined based on the title of the text of the standard.

It should be noted that, since the title of the text of a standard is used to briefly describe the content of the text of the standard, title keywords corresponding to standards with different categories can be set. For example, a title keyword corresponding to a symbol standard can be set as “symbol”, and a title keyword corresponding to a classification standard can be set as “classification”. Then it can be searched in the title of the text of the standard to determine whether a title keyword corresponding to a category is in the title, and if a title keyword corresponding to a category is in the title, it can be determined that the text of the standard belongs to this category. For example, for the text of the standard GB/T 324 with a title of “Welds-symbolic representation on drawings”, it can be determined that the standard GB/T 324 is a symbol standard because a title keyword “symbolic” of the symbol standard is in it's title.

In an embodiment, if two or more title keywords are in the title of the text of a standard, it can be determined that the standard corresponds to two or more categories at the same time. For example, for the text of the standard GB/T 18443 with a title of “Testing method of low temperature performance for vacuum insulation equipment”, it can be determined that the standard GB/T 18443 is a product standard and also a testing method standard because there are a title keyword “equipment” of a product standard and a title keyword “testing” of a testing method standard.

In an embodiment, since the initial state of the text of standard is mostly PDF version or Word version, before determining the category of the text of the standard based on the title of the text of the standard, the text of the standard can be obtained by recognizing the text of the standard with an initial state of PDF version or Word version using optical character recognition (OCR) technology, to make the obtained text of the standard be able to be recognized by machine.

Step 120, querying and determining writing elements of the text of the standard in standard writing rules based on the category of the text of the standard, and determining a head entity type, a tail entity type and an entity relationship between a head entity and a tail entity in a standard knowledge graph based on the writing elements.

In an embodiment, writing elements of the text of a standard refer to writing outlines of the text of the standard, which means that the title corresponding to each standard clause of the text of the standard can be determined after determining the writing elements of the text of the standard. After the category of the text of the standard is determined, the writing elements of the text of the standard with the corresponding category can be determined by querying in the standard writing rules (such as GB/T20001).

For example, if the category of the text of the standard indicates a product standard, the writing elements of the product standard can be obtained by querying in the column “drafting of elements” in “GB/T 20001.10 Rules for drafting standards Part 10: Product Standards”, where the writing elements of the product standard include introduction, name of a standard, scope, classification, marking and coding, technical requirements, sampling, testing methods, inspection rules, signs, labels, accompanying documents, packaging, transportation and storage.

After the writing elements of the text of the standard is determined, the head entity type, the tail entity type, and the entity relationship between the head entity and the tail entity in the standard knowledge graph can be determined according to the writing elements.

Table 1 shows an entity type-entity relationship list in a product standard knowledge graph. As shown in Table 1, for the foreword section, the head entity type can include “person” and “organization”, where the tail entity type corresponding to “person” is “standard” and the entity relationship between “person” and “standard” is “drafting”; and the tail entity type corresponding to “organization” is “standard” and the entity relationship between “organization” and “standard” is “belonging department (management), drafting, publishing”.

For the section of packaging, transportation and storage, the head entity type can include “standard clause” and “technical requirement”, where the tail entity type corresponding to “standard clause” is “packaging, transportation and storage” and the entity relationship between “standard clause” and “packaging, transportation and storage” is “regulation”; and the tail entity type corresponding to “technical requirement” is “packaging, transportation and storage” and the entity relationship between “technical requirement” and “packaging, transportation and storage” is “section”.

It can be seen that in the embodiments of the present application, by determining the head entity type, the tail entity type and the entity relationship between the head entity and the tail entity in the standard knowledge graph based on the writing elements after determining the writing elements of the text of the standard based on the category of the text of the standard, the standard knowledge graph can be constructed according to standards with different categories, which enables the constructed standard knowledge graph to accurately characterize the content information of respective standards, and then the corresponding standard data can be queried and obtained quickly and accurately from the constructed standard knowledge graph.

TABLE 1

| Number | Head Entity Type | Entity Relationship | Tail Entity Type |
|---|---|---|---|
| 1 | Person | Drafting | Standard |
| 2 | Organization | Belonging Department | Standard |
| | | (Management), Drafting, and | |
| | | Publishing | |
| 3 | Field | Classification | Standard |
| 4 | Standard | Citation | Document |
| 5 | Standard | Citation, Adoption, Reference | Standard |
| 6 | Standard | Section | Standard Clause |
| 7 | Standard Clause | Citation | Standard Clause |
| 8 | Standard Clause | Citation | Standard |
| 9 | Standard Clause | Regulation | Technical Requirement |
| 10 | Standard Clause | Regulation | Inspection Rule |
| 11 | Standard Clause | Regulation | Testing Method |
| 12 | Standard Clause | Regulation | Sampling |
| 13 | Standard Clause | Regulation | Packaging, Transportation |
| | | | and Storage |
| 14 | Standard Clause | Regulation | Classification, Marking |
| | | | and Coding |
| 15 | Standard Clause | Regulation | Sign, Label and |
| | | | Accompanying Document |
| 16 | Product | Spare Part | Product |
| 17 | Product | Basis | Standard |
| 18 | Product | Section | Sign, Label and |
| | | | Accompanying Document |
| 19 | Technical | Section | Packaging, Transportation |
| | Requirement | | and Storage |
| 20 | Technical | Description | Product |
| | Requirement | | |
| 21 | Inspection Rule | Norm | Testing Method |
| 22 | Testing Method | Verification | Technical Requirement |
| 23 | Classification, | Classification, Marking and | Product |
| | Marking and Coding | Coding | |
| 24 | Testing Method | Section | Sampling |

Step 130, extracting a head entity corresponding to the head entity type and a tail entity corresponding to the tail entity type from the text of the standard based on the head entity type, the tail entity type and the entity relationship.

In an embodiment, after the head entity type, the tail entity type and the entity relationship are determined, the head entity and the tail entity in the standard knowledge graph have not been filled with specific content data, therefore a corresponding entity extracting rule can be determined and the head entity corresponding to the head entity type and the tail entity corresponding to the tail entity type can be extracted from the text of the standard based on the head entity type, the tail entity type and the entity relationship. For example, for the head entity type “person”, the tail entity type “standard” and the entity relationship “drafting” in the foreword section, the entity extraction rule can be: taking “drafting” as a keyword, taking a sentence where “drafting” is located as a target sentence, taking the position of “drafting” in the target sentence as a demarcation point to divide the target sentence into a pre-sentence and a post-sentence, and extracting the entity in the pre-sentence as the “tail entity” and extracting the entity in the post-sentence as the “head entity”. For example, for a target sentence “this standard's (GB/T XX) drafters: person 1, person 2 and person 3”, the target sentence is divided into a pre-sentence “this standard's (GB/T XX)” and a post-sentence “person 1, person 2 and person 3” based on the keyword “drafter”, and then “GB/T XX” in the pre-sentence is extracted as the tail entity, and “person 1, person 2, person 3” in the post-sentence is extracted as the head entity. Table 2 is a reference table of the meanings corresponding to respective head entities or tail entities in a product standard. As shown in Table 2, the entity “standard” represents a standard, a citation standard, an adoption standard, etc., and the entity “person” represents a drafter of the standard, etc.

TABLE 2

| Number | Head Entity or Tail Entity | Meaning |
|---|---|---|
| 1 | Standard | Standard, Citation Standard, Adoption Standard, etc. |
| 2 | Person | Drafter of Standard, etc. |
| 3 | Organization | Belonging Department, Drafting Department, |
| | | Administrative Department, etc. of Standard |
| 4 | Document | Norm Reference Document |
| 5 | Field | Product Field, Professional Field, Standard System, etc. |
| 6 | Standard Clause | Standard Chapter and Article, etc. |
| 7 | Technical Requirement | Technical requirement that the product meets |
| 8 | Inspection Rule | Inspection Rule of Technical Requirement |
| 9 | Sampling | Sampling Method, Rule, etc. |
| 10 | Testing Method | Testing Manner and Mode |
| 11 | Packaging, Transportation and | Requirements for Packaging, Transportation and |
| | Storage | Storage of Product |
| 12 | Classification, Marking and | Classification, Marking, Coding, etc. of Product |
| | Coding | |
| 13 | Sign, Label and | Sign, Label, Accompanying Document, etc. of Product |
| | Accompanying Document | |
| 14 | Product | Main Body of Product Standard |

Step 140, performing entity filling on the standard knowledge graph based on the head entity and the tail entity.

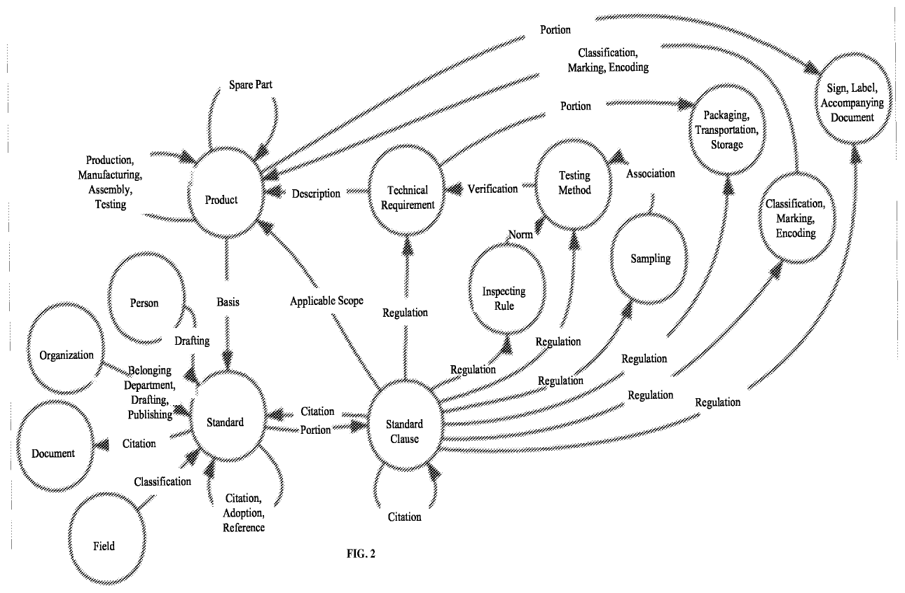

In an embodiment, after the head entity and the tail entity are determined, the corresponding head entity is filled into a corresponding node of the “head entity type” in the standard knowledge graph, and the corresponding tail entity is filled into a corresponding node of the “tail entity type” in the standard knowledge graph to construct and obtain the standard knowledge graph as shown in FIG. 2.

As shown in FIG. 2, if the category of the text of the standard is a product standard, the writing elements of the product standard can be determined based on the standard writing rules, and the head entity type, the tail entity type and the entity relationship between the head entity and the tail entity (such as the relationship “production, manufacturing, assembly, and testing” between the products shown in FIG. 2) can be determined based on the writing elements. For example, the relationship between a standard and another standard and the relationship between a standard and a field can be determined according to a standard system (such as The 13th Five Year Technical Standard System of Electronic); the application scope relationship between a standard clause and a product can be determined according to the application scope of the standard; and the relationship between a product and another product can be determined according to different positions of the products corresponding to the product standard in industrial chains, for example, chip in integrated circuit is manufactured by lithography machine, and then the relationship of the lithography machine-manufacturing-chip (integrated circuit) can be established.

In the method for constructing standard knowledge graph provided by the embodiments of the present application, by determining the category of the text of the standard based on the title of the text of the standard, determining the writing elements of the text of the standard based on the category of the text of the standard, and determining the head entity type, the tail entity type and the entity relationship between the head entity and the tail entity in the standard knowledge graph based on the writing elements, the standard knowledge graph can be constructed according to texts of the standards with different categories, which enables the constructed standard knowledge graph to accurately characterize the content information of texts of the standards with different categories, and then the corresponding standard data information can be queried and obtained quickly and accurately from the constructed standard knowledge graph, which can avoid the problem of low efficiency caused by manual reading and extracting standard data information in traditional methods.

In an embodiment, the writing elements include structured elements and unstructured elements.

In an embodiment, structured elements include common elements in various texts of standards and the texts of standards corresponding to the structured elements are written in a set format. The structured elements are divided into normative elements and informative elements according to their functions. The normative elements include scope, term and definition, symbol and abbreviation, classification and coding/system composition, general principle and/or general requirement, core technical element and other technical elements. The informative elements include cover, table of contents, foreword, introduction, normative citation, references and index. For example, “foreword” can be used as a structured element of respective texts of standards since “foreword” in respective texts of standards is written in a same set format; and “citation document” can be used as a structured element of respective texts of standards since “citation document” in respective texts of standards is written in a same set format.

In some standards, a drafter of a standard is described in a set format “the standard's drafter: XX”, and then “the standard's drafter: XX” can be used as a standard element text; and for another example, “Chapter 5” corresponds to “Clauses 5.1 to 5.6” in a text of a standard, and then a title corresponding to “Chapter 5” and titles corresponding to “Clauses 5.1 to 5.6” can be used as standard element texts. After the standard element texts are extracted, the remaining texts are regarded as non-standard element texts.

In the writing elements, except for structured elements, other elements are regarded as unstructured elements. In an embodiment, the unstructured elements can be special elements in various standards with different categories. For example, “sign, label and accompanying document” is a writing element of product standard rather than a symbol standard, therefore “sign, label and accompanying document” can be used as an unstructured element of the product standard.

In addition, it should be noted that in a text of a standard, a structured element corresponds to a structured text and an unstructured element corresponds to an unstructured text. The structured text includes full-structured text and semi-structured text. Entities can be sorted out directly based on the full-structured text which mainly corresponds to bibliography and reference document information of a standard. For example, the full-structured text includes standard's title, drafting department, drafter, and belonging department, etc. For the semi-structured text, a standard consists of a plurality of different chapters and clauses which are collectively referred to as standard clause. The standard clause, except for the set normative elements (such as scope, normative citation, term and definition), mainly describes the standard's elements including technical requirement, inspection rule, sampling, testing method, packaging, transportation, storage, classification, marking, coding, sign, label and accompanying document, etc. A title of a standard clause (such as a title of a chapter, a title of an clause) plays a role in dividing the specific content of the standard clause and can be defined as an entity. In an embodiment, according to the classification of “GB/T 35415-2017 Classification and codes for technical attribute keywords in product standard” (referred to as “Classification”), the technical requirement can be used to describe product characteristics from six aspects, such as product identification, external characteristic, sensory, performance, function, substance content. In the process of constructing standard knowledge graph, in order to clarify the technical indicators of a product, the technical indicators can be defined according to the three-level classification method (namely large classification, medium classification, and small classification) in the Classification. In an embodiment, all technical indicators have an index of large classification and an index of medium classification, but some of them do not have an index of small classification. In this embodiment, for indicators having an index of small classification, the small classification can be defined as an instance of an entity “technical requirement”, while in other cases, the medium classification is defined as an instance of an entity “technical requirement”. The “technical attribute index keywords” listed in the Classification can be classified as attribute values of the technical indicator entity.

Unstructured text refers to the content of the text of the standard except for the above-mentioned full-structured text and semi-structured text, that is, the specific content of the standard clause. For the unstructured text, it is usually needed to extract knowledge contained in the text based on semantic comprehension. In general, unstructured text includes the following entities:
\textcircled{1} the specific content, operation step, detailed description and technical indicator described in the title (semi-structured text) of the standard clause, where in case the title of the clause does not exist, corresponding contents can be extracted from such data as an instance of the standard clause for labeling, and in other cases, the extraction of such knowledge requires knowledge modeling according to business requirements and determining labeling rules;
\textcircled{2} product type included in a general title of a standard, where the title of the standard usually specifies the subject of the standard, such as the product name, and in the case that the title does not contain the product name, corresponding applicable product can be extracted from applicable scope.

According to any one of above embodiments, the determining the head entity type, the tail entity type and the entity relationship between the head entity and the tail entity in the standard knowledge graph based on the writing elements includes:
in case the writing elements are structured elements, taking a preset relationship keyword as the entity relationship, and determining the head entity type and the tail entity type based on the entity relationship; and
in case the writing elements are unstructured elements, inputting a text of the standard corresponding to the unstructured elements into a reading comprehension model and obtaining an entity relationship outputted by the reading comprehension model, and determining the head entity type and the tail entity type based on the entity relationship; where the reading comprehension model is obtained by training with a sample text of standard and an entity relationship of the sample text of standard.

In an embodiment, in case the writing elements are structured elements, a preset relationship keyword is used as the entity relationship, and the head entity type and the tail entity type are determined based on the entity relationship. For example, preset keywords can be set for structured elements, such as citation, adoption, reference, drafting, belonging department, publication, citation and classification. The above preset keywords can be used as entity relationships, and then the head entity type and the tail entity type corresponding to each entity relationship can be determined, respectively.

For example, both the head entity type and the tail entity type corresponding to preset relationship keywords “citation”, “adoption” and “reference” are standard, and then the corresponding relationships between standards are “citation”, “adoption” and “reference”; the head entity type corresponding to a preset relationship keyword “drafting” is person and the tail entity type corresponding to the preset relationship keyword “drafting” is standard, and then the corresponding relationship between person and standard is “drafting”; the head entity type corresponding to preset relationship keywords “belonging department”, “drafting” and “publication” is organization and the tail entity type corresponding to the preset relationship keywords “belonging department”, “drafting” and “publication” is standard, and then the corresponding relationships between organization and standard are “belonging department”, “drafting” and “publication”; the head entity type corresponding to a preset relationship keyword “citation” is standard and the tail entity type corresponding to the preset relationship keyword “citation” is document, and then the corresponding relationship between standard and document is “citation”; and the head entity type corresponding to a preset relationship keyword “classification” is field and the tail entity type corresponding to the preset relationship keyword “classification” is standard, and then the corresponding relationship between field and standard is “classification”, and it can be classified into a certain field through a standard field and then a hierarchical relationship between standards can be constructed through a standard system.

In addition, for the terms of standard and standard clause, standard clause is standardized technical indicator after being sorted, summarized, and classified, and is carrier of standard regulation, and standard clause is “component” of a standard. There may be instances where a standard clause cites another standard clause in the present standard, a standard clause in another standard or another standard.

In case the writing elements are unstructured elements, since the unstructured elements contain the specific description of a standard clause, it is needed to define the relationship between entities according to the usage scenarios of the standard knowledge graph under the case of semantic comprehension. In an embodiment of the present application, a text of the standard corresponding to unstructured element is inputted into a reading comprehension model to obtain an entity relationship outputted by the reading comprehension model, and then the head entity type and the tail entity type can be determined based on the entity relationship; where the reading comprehension model is obtained by training with a sample text of standard and the entity relationship of the sample text of standard.

In an embodiment, unstructured elements include the following relationships:
(1) a relationship “regulation” between a standard clause and a standard element, where the standard clause specifies the specific content of the standard element, and then the relationship between the standard clause and the standard element is “regulation”;
(2) a relationship “citation” between a standard clause and another standard clause, and between a standard clause and a standard, where in order to simplify the volume of the text of standard, a standard clause may cite another standard clause in the present standard, a standard clause in another standard, or another standard, and then by extracting the keywords described in a standard clause, a relationship “citation” between a standard clause and another standard clause, and between a standard clause and another standard can be determined;
(3) a relationship “description” between a technical requirement and a product, where the technical requirement specified in a standard describes the basic requirements that the product should meet from six aspects, and then the relationship between technical requirement and product is “description”;
(4) a relationship “spare part” between products, where product standards can be divided into design standard, performance norm standard, manufacturing inspection standard and other standards according to their contents, the contents of design standard mainly include five types of standards, which are design manual, design criteria, design calculation, parameter series and series type spectrum, and by extracting the composition and structure of a product in design manual standard, the relationship between the product and the spare part of the product can be constructed;
(5) a relationship “basis” between a product and a standard, where the product standard is an important technical content with the development of product and is an indispensable and professional technical basis for product design, manufacturing and trade activity, and the relationship between product and standard is the relationship “basis”;
(6) a relationship “verification” between a testing method and a technical requirement, where a product standard usually specifies a specific testing method to “verify” whether the product meets the technical requirement, and for product standards with different types, the defined testing method and verification relationship can be further divided into two types: the first is design standard, and in the design process, product parameters needed to be determined are usually obtained by calculation methods, therefore the verification method can be “calculation method” at this time and the verification relationship can be “calculation”; and the second is that in the process of product inspection, technical parameters of the product are usually confirmed by “testing method”, and then the verification relationship can be “experiment”;
(7) a relationship “citation” between a standard clause and another standard clause, where the standards may be intersected with each other owing to the relevance between products, therefore there is usually a “citation” relationship between a standard clause and another standard clause;
(8) a regulation relationship between a standard clause and a verification method, and a standard clause and a technical indicator, where the standard, as a stipulation of document, substance, behavior, phenomenon, etc. approved by the accreditation body, plays a role in specifying corresponding products, and this function is achieved by specifying corresponding technical indicator and their verification method; in addition, chart, diagram, etc. should be considered as parts of a standard clause and the relationship between a standard clause and a verification method, and between a standard clause and a technical indicator is regulation;
(9) a relationship “portion” between a product and a sign, a label and an accompanying document, where the sign, the label and the accompanying document are usually attached to the product and are present as a portion of the product, and then the relationship between them and the product is “portion”;
(10) a relationship “portion” between a technical requirement and packaging, transportation and storage, where packaging, transportation and storage of products can be specified separately in the standard, but since these regulations are also classified as technical requirement, the relationship between them and technical requirement is “portion”;
(11) a relationship “normative” between inspection rule and testing method, where the inspection rule is a rule, procedure or method, etc. used to measure, inspect and verify the product's compliance with technical requirement for one or more characteristics of the product, therefore the relationship between inspection rule and testing method is “normative”;
(12) a relationship “classification, marking and coding” between classification, marking and coding and a product, where a classification (grading), marking and coding system is established for product by classification, marking and coding, and then the corresponding relationship is “classification”, “marking”, “coding”.
(13) a relationship “portion” between testing method and sampling, where a sampling method specified in a standard may be classified into the testing method of the standard, or may exist as a separate part, and when this occurs, the relationship between testing method and sampling is “portion”.

Based on any one of above embodiments, the extracting the head entity corresponding to the head entity type and the tail entity corresponding to the tail entity type from the text of the standard based on the head entity type, the tail entity type and the entity relationship includes:
determining an entity extraction rule based on the head entity type, the tail entity type and the entity relationship, and extracting the head entity corresponding to the head entity type and the tail entity corresponding to the tail entity type from the text of the standard based on the entity extraction rule.

In an embodiment, after determining the head entity type, the tail entity type and the entity relationship, the head entity and the tail entity in the standard knowledge graph have not been filled with specific content data, and then it is possible to determine corresponding entity extracting rule and extract the head entity corresponding to the head entity type and the tail entity corresponding to the tail entity type from the text of the standard based on the head entity type, the tail entity type and the entity relationship.

For example, for the head entity type “person”, the tail entity type “standard” and the entity relationship “drafting” in the structured element of foreword section, the entity extraction rule can be: taking “drafting” as a keyword, taking a sentence where “drafting” is located as a target sentence, taking the position of “drafting” in the target sentence as a demarcation point to divide the target sentence into a pre-sentence and a post-sentence, and extracting the entity in the pre-sentence as the “tail entity” and extracting the entity in the post-sentence as the “head entity”. For example, for a target sentence “this standard's (GB/T XX) drafters: person 1, person 2 and person 3”, the target sentence is divided into a pre-sentence “this standard's (GB/T XX)” and a post-sentence “person 1, person 2 and person 3” based on the keyword “drafter”, and then “GB/T XX” in the pre-sentence is extracted as the tail entity, and “person 1, person 2, person 3” in the post-sentence is extracted as the head entity.

Writing elements include structured elements and also unstructured elements. The difference between the unstructured elements and the structured elements is that there is no set format for the semantic expression of a text of standard corresponding to the unstructured elements. For example, “the maximum speed limit of an electric bicycle is s” can be expressed as “the speed of an electric bicycle is not greater than s”, or can also be expressed as “vehicles with a maximum speed limit of s include electric bicycle”. It can be seen that, for a same semantic meaning, there are many different ways to express the text of standard corresponding to the unstructured elements, so it is possible to obtain entity relationship keywords corresponding to the unstructured elements and extract corresponding head entity and tail entity by means of semantic comprehension (e.g., based on a reading comprehension model).

Based on any one of above embodiments, the determining the category of the text of the standard includes:
determining whether a preset title keyword is in a title of the text of the standard; and
in case the preset title keyword is in the title of the text of the standard, determining the category of the text of the standard based on a mapping relationship between the preset title keyword and the category of the text of the standard; and
in case the preset title keyword is not in the title of the text of the standard, determining the category of the text of the standard based on a text content in a specified item in the text of the standard.

In an embodiment, the title of the text of the standard is used to briefly describe the content of the text of the standard, and the categories of the text of the standard can include symbol standard, classification standard, testing method standard, norm standard, procedure standard, guideline standard, principle, requirement, and rule and other types of standard and product standard, etc. When determining the category of the text of the standard, it is possible to first determine whether a preset title keyword is in the title of the text of the standard, and if the preset title keyword is in the title of the text of the standard, determining the category of the text of the standard based on the mapping relationship between the preset title keyword and the category of the text of the standard. Where the preset title keyword can include a symbol, a classification, a testing method, a norm, a procedure, a guideline, a product, and the like.

It should be noted that, since the title of the text of a standard is used to briefly describe the content of the text of the standard, preset title keywords corresponding to standards with different categories can be set. For example, a title keyword corresponding to a symbol standard can be set as “symbol”, and a title keyword corresponding to a classification standard can be set as “classification”. Then it can be searched in the title of the text of the standard to determine whether a title keyword corresponding to a category is in the title, and if the title keyword corresponding to a category is in the title, it can be determined that the text of the standard belongs to this category. For example, for the text of the standard GB/T 324 with a title of “Welds-symbolic representation on drawings”, it can be determined that the standard GB/T 324 is a symbol standard because a title keyword “symbolic” of the symbol standard is in it's title.

If the preset title keyword is not in the title of the text of the standard, it is possible to determine the category of the text of the standard based on a text content in a specified item in the text of the standard. For example, the category of the text of the standard can be determined by the content of “applicable scope” in the text of the standard.

A device for constructing standard knowledge graph provided by the present application is described below, and the device for constructing standard knowledge graph described below and the method for constructing standard knowledge graph described above can be cross-referenced with each other.

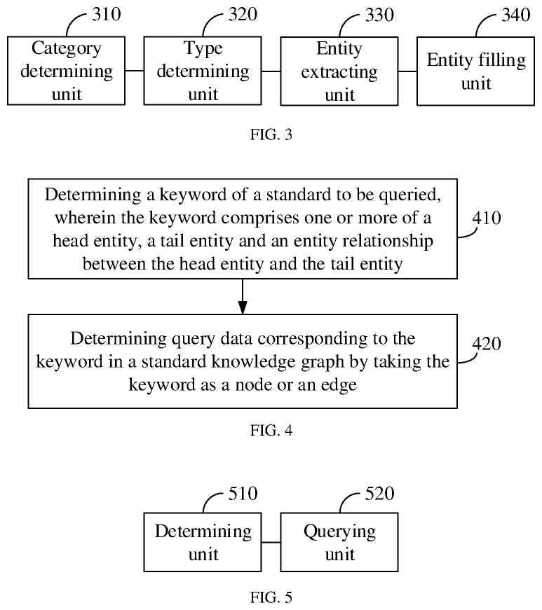

The present application provides a device for constructing standard knowledge graph. As shown in FIG. 3, the device includes:
a category determining unit 310, configured to determine a category of a text of a standard;
a type determining unit 320, configured to query and determine writing elements of the text of the standard in standard writing rules based on the category of the text of the standard, and determine a head entity type, a tail entity type and an entity relationship between a head entity and a tail entity in a standard knowledge graph based on the writing elements;
an entity extracting unit 330, configured to extract a head entity corresponding to the head entity type and a tail entity corresponding to the tail entity type from the text of the standard based on the head entity type, the tail entity type and the entity relationship; and
an entity filling unit 340, configured to perform entity filling on the standard knowledge graph based on the head entity and the tail entity.

Based on any one of above embodiments, the writing elements include structured elements and unstructured elements.

Based on any one of above embodiments, the type determining unit 320 includes:
a first determining unit, configured to take a preset relationship keyword as the entity relationship and determine the head entity type and the tail entity type based on the entity relationship in case the writing elements are structured elements;
a second determining unit, configured to input a text of the standard corresponding to the unstructured elements into a reading comprehension model and obtain an entity relationship outputted by the reading comprehension model in case the writing elements are unstructured elements, and determine the head entity type and the tail entity type based on the entity relationship; where the reading comprehension model is obtained by training with a sample text of standard and an entity relationship of the sample text of standard.

Based on any one of above embodiments, the entity extracting unit 330 is configured to: determine an entity extraction rule based on the head entity type, the tail entity type and the entity relationship, and extract the head entity corresponding to the head entity type and the tail entity corresponding to the tail entity type from the text of the standard based on the entity extraction rule.

Based on any one of above embodiments, the type determining unit 310 is configured to:
determine whether a preset title keyword is in a title of the text of the standard; and
in case the preset title keyword is in the title of the text of the standard, determine the category of the text of the standard based on a mapping relationship between the preset title keyword and the category of the text of the standard; and
in case the preset title keyword is not in the title of the text of the standard, determine the category of the text of the standard based on a text content in a specified item in the text of the standard.

The present application also provides a method for querying standard, as shown in FIG. 4, the method includes:
step 410, determining a keyword of a standard to be queried, wherein the keyword comprises one or more of a head entity, a tail entity and an entity relationship between the head entity and the tail entity; and
step 420, determining query data corresponding to the keyword in a standard knowledge graph by taking the keyword as a node or an edge;
where, the standard knowledge graph is obtained according to the method for constructing standard knowledge graph described in any one of above embodiments.

In an embodiment, the keyword of the standard to be queried includes one or more of a head entity, a tail entity and an entity relationship between the head entity and the tail entity. For example, the keyword of the standard to be queried can be a standard clause, or can be a certain keyword, which is not limited in the embodiments of the present application. After inputting the keyword of the standard, the corresponding query data of the keyword can be obtained quickly and accurately in the standard knowledge graph by taking the keyword as a node or an edge, which can avoid the problem of low efficiency caused by manual reading and extracting standard data information in traditional methods.

A device for querying standard provided by the present application is described below, and the device for querying standard described below and the method for querying standard described above can be cross-referenced with each other.

The present application provides a device for querying standard. As shown in FIG. 5, the device includes:
a determining unit 510, configured to determine a keyword of a standard to be queried, wherein the keyword comprises one or more of a head entity, a tail entity and an entity relationship between the head entity and the tail entity; and
a querying unit 520, configured to determine query data corresponding to the keyword in a standard knowledge graph by taking the keyword as a node or an edge;
where the standard knowledge graph is obtained according to the method for constructing standard knowledge graph described in any one of above embodiments.

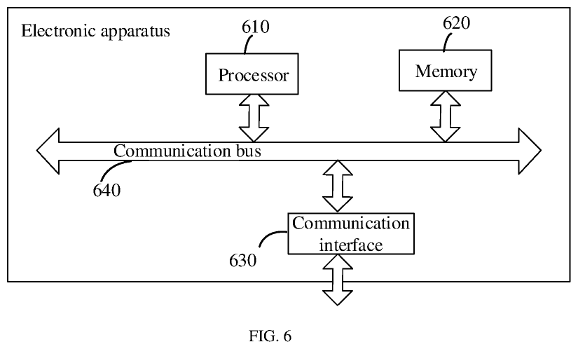

FIG. 6 is a schematic structural diagram of an electronic apparatus provided the present application. As shown in FIG. 6, the electronic apparatus can include a processor 610, a memory 620, a communication interface 630 and a communication bus 640 through which the processor 610, the memory 620, and the communication interface 630 communicate with each other. The processor 610 can call logic instructions in the memory 620 to execute a method for constructing standard knowledge graph, where the method includes: determining a category of a text of a standard; querying and determining writing elements of the text of the standard in standard writing rules based on the category of the text of the standard, and determining a head entity type, a tail entity type and an entity relationship between a head entity and a tail entity in a standard knowledge graph based on the writing elements; extracting a head entity corresponding to the head entity type and a tail entity corresponding to the tail entity type from the text of the standard based on the head entity type, the tail entity type and the entity relationship; and performing entity filling on the standard knowledge graph based on the head entity and the tail entity.

And/or, the processor 610 can call logic instructions in the memory 620 to execute a method for querying standard, where the method includes: determining a keyword of a standard to be queried, where the keyword comprises one or more of a head entity, a tail entity and an entity relationship between the head entity and the tail entity; and determining query data corresponding to the keyword in a standard knowledge graph by taking the keyword as a node or an edge; where the standard knowledge graph is obtained according to the method for constructing standard knowledge graph described above.

In addition, the above-mentioned logic instructions in the memory 620 can be implemented in the form of software functional units and can be stored in a computer-readable storage medium when sold or used as an independent product. Based on this understanding, the solutions of the present application or the part that contributes to the related art or the part of the solutions can be embodied in the form of a software product in essence. The computer software product is stored in a storage medium, including several instructions used to cause a computer device (such as a personal computer, a server, or a network device, etc.) to execute all or part of the steps of the methods described in the various embodiments of the present application. The aforementioned storage medium includes: USB flash memory, mobile hard disk, Read-Only Memory (ROM), Random Access Memory (RAM), magnetic disk or optical disk and other media that can store program codes.

In another aspect, the present application provides a computer program product. The computer program product includes a computer program stored on a non-transitory computer-readable storage medium, and the computer program includes program instructions. When the program instructions are executed by a computer, the computer is able to perform the method for constructing standard knowledge graph provided by above embodiments, where the method includes: determining a category of a text of a standard; querying and determining writing elements of the text of the standard in standard writing rules based on the category of the text of the standard, and determining a head entity type, a tail entity type and an entity relationship between a head entity and a tail entity in a standard knowledge graph based on the writing elements; extracting a head entity corresponding to the head entity type and a tail entity corresponding to the tail entity type from the text of the standard based on the head entity type, the tail entity type and the entity relationship; and performing entity filling on the standard knowledge graph based on the head entity and the tail entity.

And/or, when the program instructions are executed by the computer, the computer is able to execute a method for querying standard, where the method includes: determining a keyword of a standard to be queried, where the keyword comprises one or more of a head entity, a tail entity and an entity relationship between the head entity and the tail entity; and determining query data corresponding to the keyword in a standard knowledge graph by taking the keyword as a node or an edge; where the standard knowledge graph is obtained according to the method for constructing standard knowledge graph described above.

In another aspect, the present application also provides a non-transitory computer-readable storage medium having a computer program stored thereon, where the computer program, when executed by a processor, causes the processor to perform the steps of any method for constructing standard knowledge graph described above, where the method includes: determining a category of a text of a standard; querying and determining writing elements of the text of the standard in standard writing rules based on the category of the text of the standard, and determining a head entity type, a tail entity type and an entity relationship between a head entity and a tail entity in a standard knowledge graph based on the writing elements; extracting a head entity corresponding to the head entity type and a tail entity corresponding to the tail entity type from the text of the standard based on the head entity type, the tail entity type and the entity relationship; and performing entity filling on the standard knowledge graph based on the head entity and the tail entity.

And/or, the computer program, when executed by the processor, causes the processor to perform the steps of any method for querying standard, where the method includes: determining a keyword of a standard to be queried, where the keyword comprises one or more of a head entity, a tail entity and an entity relationship between the head entity and the tail entity; and determining query data corresponding to the keyword in a standard knowledge graph by taking the keyword as a node or an edge; where the standard knowledge graph is obtained according to the method for constructing standard knowledge graph described above.

The device embodiments described above are only illustrative, in which the unit described as a separate component may be or may not be physically separated, and the component displayed as a unit may be or may not be a physical unit. That is, it may be located in one position or may be distributed to multiple network units. Some or all of the modules may be selected according to the actual needs to achieve the purpose of the solutions in these embodiments. Those of ordinary skill in the art may understand and implement these embodiments without creative effort.

From the description of the above embodiments, those skilled in the art can clearly understand that each embodiment can be implemented by means of software plus a necessary general hardware platform, and certainly can also be implemented by hardware. Based on this understanding, the above solutions or the part of the solutions that contributes to the related art can be embodied in the form of a software product, and the computer software products can be stored in computer-readable storage media, such as ROM/RAM, magnetic disk, optical disk or the like, including several instructions for causing a computer device (which can be a personal computer, a server, or a network equipment or the like) to perform the methods described in various embodiments or some parts of the embodiments.

Finally, it should be noted that the above embodiments are only used to illustrate the solutions of the present application, but not to limit them; although the present application has been described in detail with reference to the foregoing embodiments, those of ordinary skill in the art should understand that: they can still modify the solutions described in the foregoing embodiments, or equivalently replace some features thereof; while these modifications or replacements do not make the essence of the corresponding solutions deviate from the scope of the solutions in the embodiments of the present application.

1. A method for constructing standard knowledge graph, comprising:
determining a category of a text of a standard;
querying and determining writing elements of the text of the standard in standard writing rules based on the category of the text of the standard, and determining a head entity type, a tail entity type and an entity relationship between a head entity and a tail entity in a standard knowledge graph based on the writing elements;
extracting a head entity corresponding to the head entity type and a tail entity corresponding to the tail entity type from the text of the standard based on the head entity type, the tail entity type and the entity relationship;
performing entity filling on the standard knowledge graph based on the head entity and the tail entity;
wherein, the determining the category of the text of the standard comprises:
determining whether there is a preset title keyword in a title of the text of the standard; and
when there is the preset title keyword in the title of the text of the standard, determining the category of the text of the standard based on a mapping relationship between the preset title keyword and the category of the text of the standard; and
when there is not the preset title keyword in the title of the text of the standard, determining the category of the text of the standard based on a text content in a specified item in the text of the standard.

2. The method for constructing standard knowledge graph according to claim 1, wherein the writing elements comprise structured elements and unstructured elements.

3. The method for constructing standard knowledge graph according to claim 2, wherein the determining the head entity type, the tail entity type and the entity relationship between the head entity and the tail entity in the standard knowledge graph based on the writing elements comprises:
when the writing elements are structured elements, taking a preset relationship keyword as the entity relationship, and determining the head entity type and the tail entity type based on the entity relationship; and
when the writing elements are unstructured elements, inputting a text of the standard corresponding to the unstructured elements into a reading comprehension model and obtaining an entity relationship outputted by the reading comprehension model, and determining the head entity type and the tail entity type based on the entity relationship;
wherein the reading comprehension model is obtained by training with a sample text of standard and an entity relationship of the sample text of standard.

4. The method for constructing standard knowledge graph according to claim 1, wherein the extracting the head entity corresponding to the head entity type and the tail entity corresponding to the tail entity type from the text of the standard based on the head entity type, the tail entity type and the entity relationship comprises:
determining an entity extraction rule based on the head entity type, the tail entity type and the entity relationship, and extracting the head entity corresponding to the head entity type and the tail entity corresponding to the tail entity type from the text of the standard based on the entity extraction rule.

5. (canceled)

6. A method for querying standard, comprising:
determining a keyword of a standard to be queried, wherein the keyword comprises one or more of a head entity, a tail entity and an entity relationship between the head entity and the tail entity; and
determining query data corresponding to the keyword in a standard knowledge graph by taking the keyword as a node or an edge;
wherein the standard knowledge graph is obtained according to the method for constructing standard knowledge graph of claim 1.

7. An electronic apparatus, comprising a processor and a memory storing computer program that is executable by the processor, wherein the computer program, when executed by the processor, causes the processor to perform steps of the method for constructing standard knowledge according to claim 1.

8. A non-transitory computer-readable storage medium having a computer program stored thereon, wherein the computer program, when executed by a processor, causes the processor to perform the steps of the method for constructing standard knowledge according to claim 1.

9. A device for constructing standard knowledge graph, comprising:
a category determining unit configured to determine a category of a text of a standard;
a type determining unit configured to query and determine writing elements of the text of the standard in standard writing rules based on the category of the text of the standard, and determine a head entity type, a tail entity type and an entity relationship between a head entity and a tail entity in a standard knowledge graph based on the writing elements;
an entity extracting unit configured to extract a head entity corresponding to the head entity type and a tail entity corresponding to the tail entity type from the text of the standard based on the head entity type, the tail entity type and the entity relationship; and
an entity filling unit configured to perform entity filling on the standard knowledge graph based on the head entity and the tail entity;
wherein the category determining unit is further configured to:
determine whether there is a preset title keyword in a title of the text of the standard; and
when there is the preset title keyword in the title of the text of the standard, determine the category of the text of the standard based on a mapping relationship between the preset title keyword and the category of the text of the standard; and
when there is not the preset title keyword in the title of the text of the standard, determine the category of the text of the standard based on a text content in a specified item in the text of the standard.

10. A device for querying standard, comprising:
a determining unit configured to determine a keyword of a standard to be queried, wherein the keyword comprises one or more of a head entity, a tail entity and an entity relationship between the head entity and the tail entity; and
a querying unit configured to determine query data corresponding to the keyword in a standard knowledge graph by taking the keyword as a node or an edge;
wherein the standard knowledge graph is obtained according to the method for constructing standard knowledge graph of claim 1.

11. (canceled)

12. (canceled)
